(19) United States
(12) Patent Application Publication
(10) Pub. No.: US 2006/0136217 A1
(43) Pub. Date: Jun. 22, 2006

(54) Portable speech and language video monitor

(76) Inventor: Sheila Ann Mullin, Weston, FL (US)

Correspondence Address: Sheila Ann Mullin, 152 KINSELLA AVE, MASSAPEQUA PARK, NY, 11762, US

(21) Appl. No.: 10/998,125

(22) Filed: Nov. 27, 2004

(51) Int. Cl. G10L 21/00

(52) U.S. Cl. 704/270

(57) ABSTRACT

There are many video monitors and products that promote speech and language development on the market today. However, what is new in the art to which my invention pertains, is the concept of a portable, adjustable computerized speech and language teacher housed inside a video monitor that actually attaches to various infant furniture. This monitor will exhibit and verbally label pictures of common objects while attached to infant car seats, bouncy chairs, cribs, play yards, highchairs and exersaucers. This invention provides children with an opportunity to learn and develop early speech and language skills through repetition of seeing pictures and hearing their labels. It is similar to flash cards but it is computerized and requires no parent interaction.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING

Not Applicable

### BACKGROUND OF INVENTION

The inventor of this utility is a Licensed Speech-Language Pathologist. Therefore, the Inventor has a thorough understanding of speech and language development. Children learn speech and language in many ways including but not limited to human interaction, television, books, labeling of objects and repetition. Many children in the United States today are speech and language delayed. There are many known and unknown reasons why some children are delayed while others are not. This fact along with the inventors experience prompted the idea for this invention. This invention will assist parents in exposing children to speech and language and speaking at the earliest age possible.

### BRIEF SUMMARY OF INVENTION

In summary, the present invention is a portable and adjustable speech and language video monitor that attaches to infant furniture such as cribs, high chairs, play yards, bouncy chairs, infant car seats and exersaucers. The monitor will present realistic and colored pictures of common objects and words from categories such as food, drinks, clothing, colors, animals, transportation, toys, body parts, weather, utensils, furniture etc. This device will enable infants 0-16 months to learn vocabulary words both receptively and expressively through viewing realistic pictures presented on the video monitor. The monitor will display a picture and a computer generated voice will say the words through speakers built into the anterior portion of the monitor. It is similar to flashcards but parent participation is not necessary, only if desired.

### BRIEF DESCRIPTION OF THE SEVERAL VIEWS OF THE DRAWINGS

FIG. 1: An anterior view of the video monitor showing both the retractable U shaped clips on the top of the monitor and the retractable and fully extended C Clamps located at the bottom of the monitor.

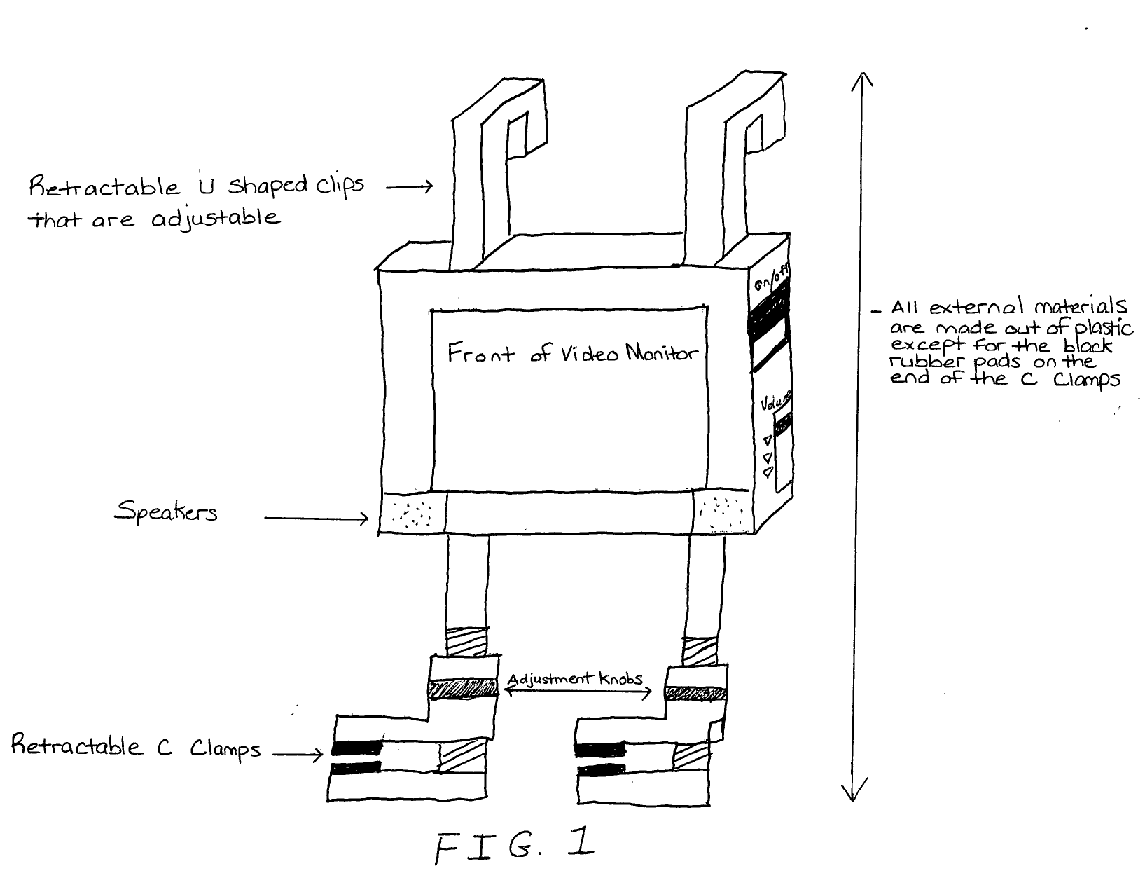

FIG. 1A: An anterior view of the video monitor showing the U shaped clips attached to the top of the monitor fully extended. This figure also displays the retracted C clamps located on the bottom of the video monitor.

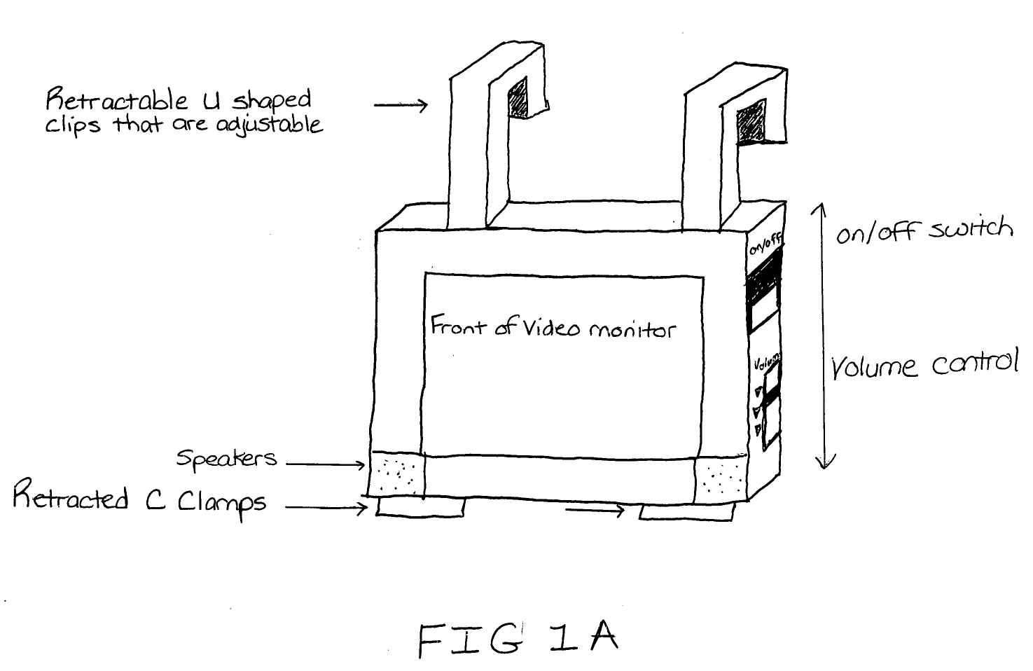

FIG. 1B: An anterior view of the monitor that shows the retractable C clamps fully extended at the bottom of the monitor. This drawing also illustrates the U shaped clips at the top of the monitor retracted and not being utilized.

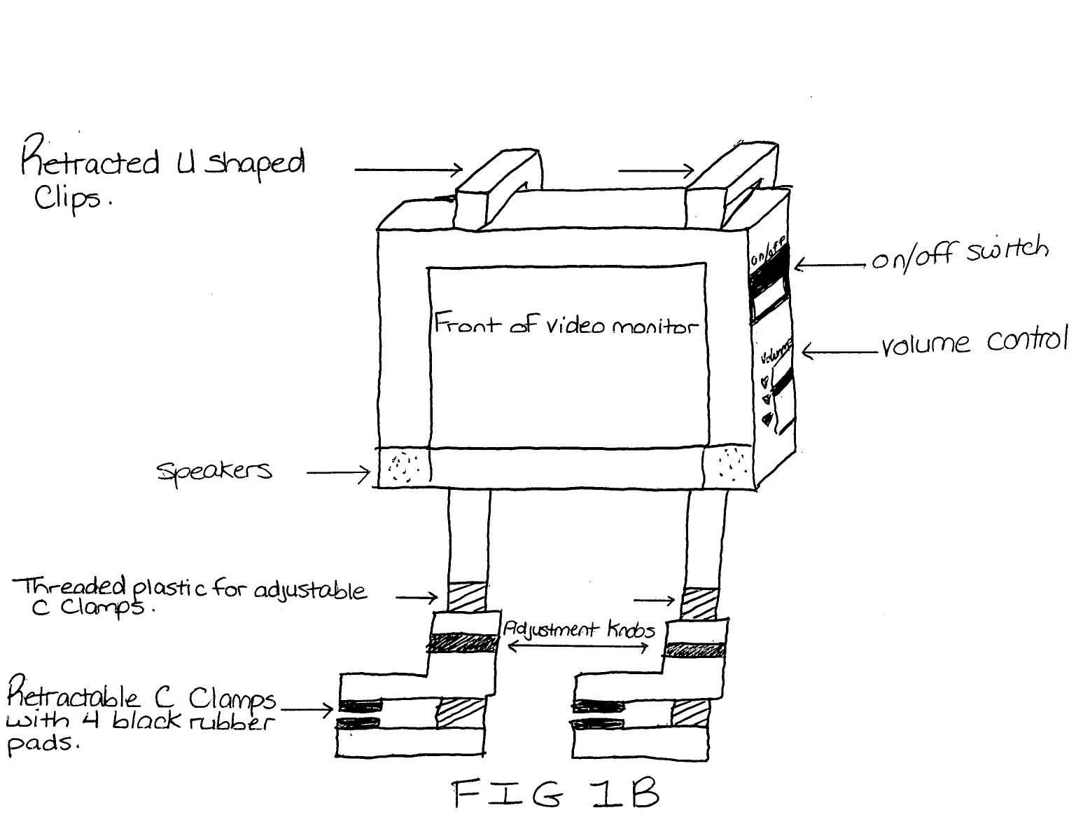

FIG. 2: This drawing illustrates a lateral view of the C clamp located at the bottom of the monitor being utilized to attach the monitor to a standard child high chair. Let it be noted that this clamp will also attach this monitor to other child safety furniture such as a bouncy chair, infant car seat and exersaucer.

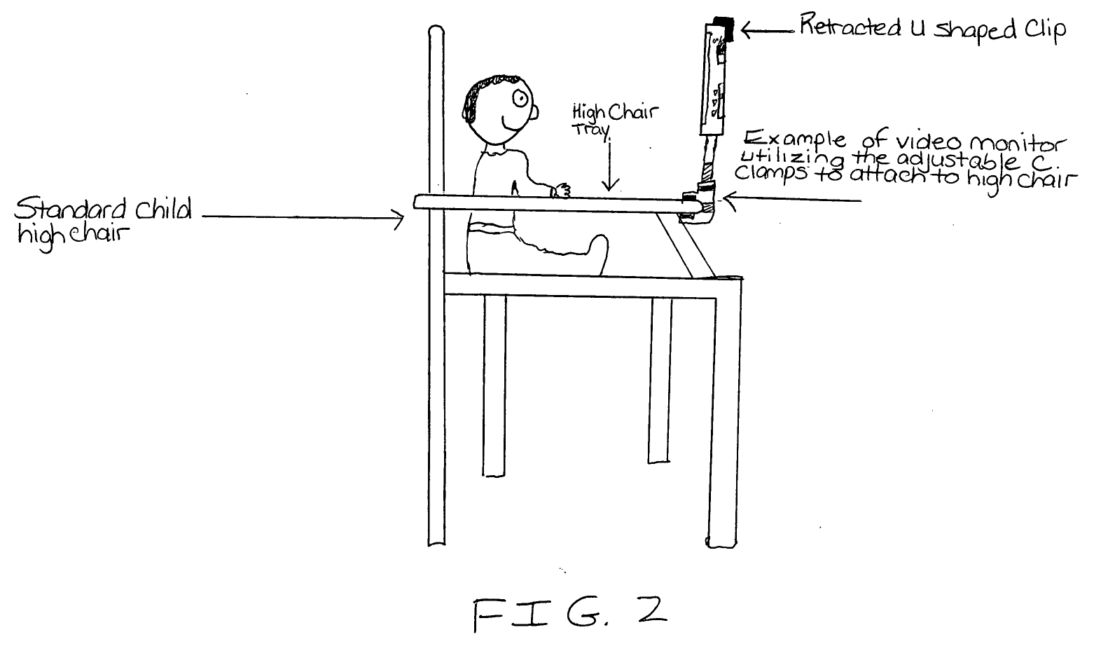

FIG. 3: This drawing illustrates the monitor utilizing the top U shaped clips to attach to a standard play yard. Let it be noted that this U shaped clip will also attach the monitor to a crib in the same fashion as illustrated in this drawing.

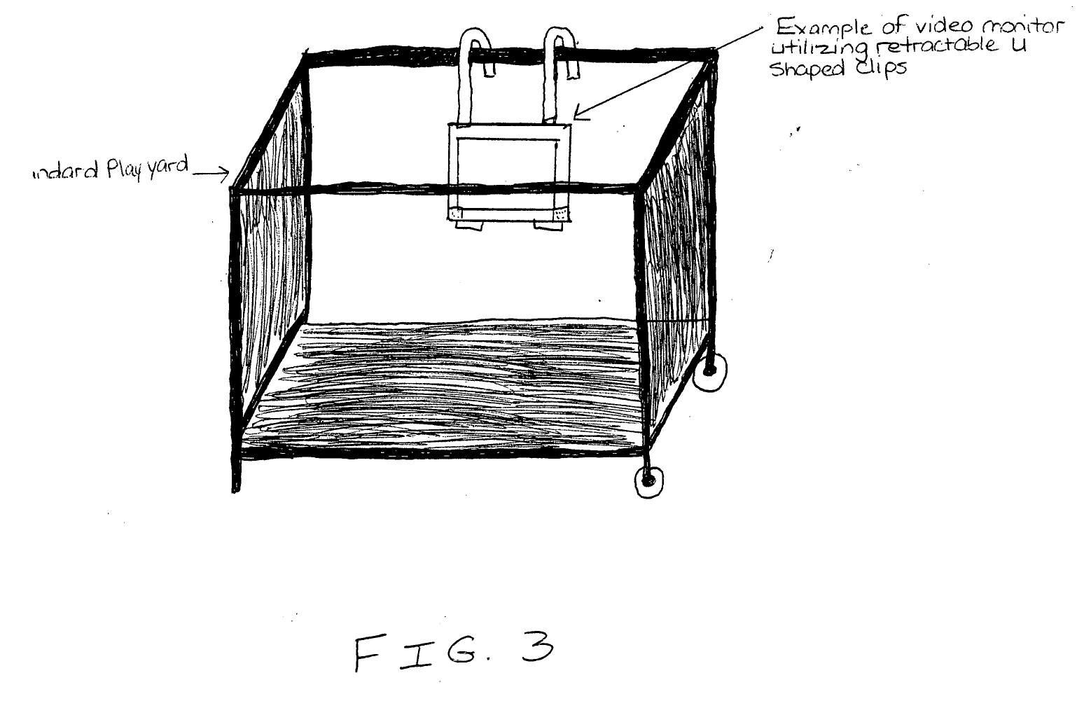

### DETAILED DESCRIPTON OF THE INVENTION

An adjustable and portable video monitor that attaches to infant bouncy chairs, cribs, play yards, infant car seats, exersaucers and high chairs. The screen will repeatedly exhibit and verbally label pictures of common objects and words with the purpose of increasing a baby's speech and language skills and promoting speech at the earliest possible age. This utility will increase a baby's expressive and receptive language skills through repetition of visual and auditory sensory modes. The baby will see a colored picture appear on a screen and a computer generated realistic human voice will label the picture. It is similar to flashcards, but parents do not have to participate unless desired. There will be a sequence of categorized pictures that will repeat themselves a certain amount times and then change categories (i.e. food, drinks, utensils, body parts, clothes, toys, colors, animals, transportation, furniture, weather, etc.). For example, the clothing category would consist items such as “shirt”, “pants”, “shoes”, “socks”, “hat”, “gloves” etc. The toy category would include items such as “ball”, “bubbles”, “bear”, “duck”, “doll”, “car” etc. Children learn through repetition. The pictures will be colorful and realistic to keep a baby's attention and the voice labeling the pictures will be soothing. There are many video monitors on the market today. However, this monitor differs by it's function (computerized speech and language teacher) and ability to attached to multiple places an infant may sit or lay.

The video monitor will be approximately 9 inches wide and 8 inches high. The monitor will house a screen for pictures that will be approximately 5 inches wide and 4 inches high The video monitor will have two speakers on the right and left side below the screen. The volume control and on/off switch will be located on the side of the monitor frame. This device has retractable U shaped clips located on the top portion of the monitor. The purpose of these clips is to mount the monitor on an infant play yard or crib. These clips are adjustable to accommodate various styles and heights of cribs and play yards. This device also has retractable C clamps located at the base of the monitor. These C Clamps have an adjustment knob on the top portion of the clamp that will raise the clamp up and down the plastic threads. This allows the clamp to attach to different size objects. The C clamp also has two rubber pads on the top and bottom of each clamp. These rubber pads are used to obtain a tight and secure grip. The purpose of these C clamps is to attach the monitor to a high chair, bouncy chair, exersaucer or infant car seat.

Having described the invention in detail and by reference to the preferred embodiments, it will be apparent that modifications and variations thereof are possible without departing from the scope of the invention. In addition, this speech and language device can be made and sold in multiple languages.

1. A portable, adjustable, computerized speech and language teacher that is housed inside a video monitor that attaches onto infant bouncy chairs, cribs, play yards, exersaucers, infant car seats and high chairs.

2-5. (canceled)

6. A portable, adjustable computerized speech and language teacher that is housed inside a video monitor that will assist children in speaking at the earliest age possible.

7. A portable, adjustable computerized speech and language teacher that is housed inside a video monitor that will increase children's expressive and receptive vocabulary through repetition of seeing objects and hearing their labels all while resting safely and comfortably in a bouncy chair, crib, play yard, exersaucer, infant car seat or high chair.
